(19) United States
(12) Patent Application Publication
(10) Pub. No.: US 2026/0290636 A1
(43) Pub. Date: Sep. 24, 2026

(54) HEAT-GENERATING NUCLEAR REACTOR WITH LIQUID METAL COOLANT AND CORE COMPRISING COOLANT-SEALED TUBES EACH HOUSING "TRISO" NUCLEAR FUEL PARTICLES

(71) Applicant: COMMISSARIAT A L'ENERGIE ATOMIQUE ET AUX ENERGIES ALTERNATIVES, Paris (FR)

(72) Inventor: Edouard HOURCADE, Aix en Provence (FR)

(21) Appl. No.: 19/490,050

(22) PCT Filed: Jun. 13, 2024
(86) PCT No.: PCT/EP2024/066378

§ 371 Date: Dec. 4, 2025

(30) Foreign Application Priority Data
Jun. 13, 2023 (FR) 2306024

(51) Int. Cl. G21C 15/247; G21C 3/62; G21C 15/28

(52) U.S. Cl. CPC G21C 15/247; G21C 3/626; G21C 15/28

(57) ABSTRACT

A liquid-metal-cooled nuclear reactor including vessel, called primary vessel, which exhibits symmetry of revolution about a central axis, filled with a coolant containing at least one liquid metal as reactor primary circuit coolant, the vessel including a core having a plurality of sealed and fixed hollow tubes, arranged parallel to the axis periphery, each hollow tube housing a stack of fuel assemblies, housing TRISO nuclear fuel particles mixed with a matrix.

### TECHNICAL FIELD

The present invention concerns the field of solid fuel nuclear reactors cooled by one or more heat transfer fluids of liquid metal type, in particular liquid sodium.

The invention therefore has for its main objective providing a heat-generating nuclear reactor that operates at a low pressure, typically below 5 bar, and is intended to provide a relatively high thermal power of the order of a few tens to hundreds of MWth.

In particular the invention aims to produce mainly thermal coupling between a nuclear reactor and an industrial production site, for example a chemical installation for the production of ammonia or sodium carbonate.

By “heat-generating” is meant here and in the context of the invention a nuclear installation, a nuclear power station or a nuclear reactor the power from which can be for the most part dedicated to the supply of heat. The power of a heat-generating reactor can be devoted 100% to supplying heat. In its heat-generating configuration a small proportion of its power can nevertheless serve to supply electricity.

Although described with reference to a nuclear reactor cooled by liquid sodium the invention can apply to any other liquid metal, such as lead, used as a heat transfer fluid in a nuclear reactor primary circuit.

Equally, although described with reference to a reactor operating in the thermal spectrum, the invention can also apply to rapid neutron reactors.

The invention can apply to small modular reactors (SMR) typically operating at a power less than or equal to 150 MWth.

Here and in the context of the invention the expression “small modular reactor” has the usual technological sense, namely a fission nuclear reactor of smaller size and power than conventional PWR type reactors, manufactured in a factory and transported to a nuclear site to be installed there.

### PRIOR ART

One of the current development areas for nuclear reactors concerns so-called heat-generating reactors intended to supply thermal power.

Of the various existing technological solutions that supply heat by nuclear fission it is commonly accepted that at present pressurized water reactors (PWR) are the most suitable for supplying heat at a relatively low temperature.

In other words PWR enable immediate supply of power at a level of a few tens of MWth, mainly for supplying so-called urban heat, that is to say in urban networks, for towns/built up areas with several hundred thousand inhabitants.

Boiling water reactors (BWR) are for producing steam in a primary circuit exploited directly in a turbo-alternator group to produce electricity.

Industrial heat at levels above those required for urban heat, generally above 500° C., at present represents more than 20% of worldwide energy demand.

To be more precise the world market for heat is around 57 000 TWh, of which approximately half is for industry, that is to say industrial production sites: [1].

It is already accepted that solutions such as SMR could contribute to some degree to replacing the 75% of industrial heat produced from oil, coal and natural gas.

Apart from their simplicity of use and their compactness, enabling them to be transported by terrestrial routes, candidate SMR type reactors have to offer intrinsic safety.

The inventor has drawn up a list of existing mature technologies that could be used in SMR type nuclear reactors to supply heat at a relatively high temperature on industrial sites that are difficult to decarbonize by electricity, such as installations for production of ammonia or sodium carbonate.

High temperature reactors (HTR) are thermal spectrum reactors with graphite moderator cooled by a heat transfer fluid referred to as “transparent” to neutrons. They offer the possibility of achieving high heat transfer fluid temperatures, typically of the order of 750° C. at the exit from the core.

In some recent designs this heat transfer fluid is pressurized helium. In another recent design, the Hermes demonstrator from Kairos Power, there has been envisaged a so-called ionic heat transfer medium consisting of molten salts based on fluoride salts.

In an HTR type reactor the nuclear fuel employed consists of tristructural isotope (TRISO) particles. Each particle is formed by a uranium oxide core coated with layers based on carbon-containing compounds that serve as a first confinement barrier to retain the fission products. The particles have the appearance of balls approximately 1 millimeter thick. They are compacted in graphite matrices (referred as pebble beds) so that the heat transfer medium is not in direct contact with the first confinement barrier.

The architecture of HTR type reactors is generally of the loop type, that is to say with heat exchangers between primary and secondary circuits connected to the core by tubular connections, and employs fluid circulators, i.e. pumps, blowers and heat exchangers exchanging heat with the fluid in the secondary circuit, which can be helium, water under pressure, supercritical CO₂, etc.

In HTR type reactors the thermal transfer between the first confinement barrier and the heat transfer medium is effected by conduction through interfaces consisting of the graphite matrix in which the TRISO particles are compacted.

HTR type reactors have the following major advantages:
the TRISO fuel particles used enable high pressures and temperatures to be accommodated in the case of incidents or accidents; the temperature of the fuels can typically be greater than 1500° C. and the internal pressure of the heat transfer medium (helium) can be between 10 bar and 100 bar;
a neutron spectrum can be highly thermic, which leads to a high Doppler and moderator coefficient, typically equal to −15 pcm/° C., and therefore leads to rapid variation of the power of the reactor in the event of temperature variations in the graphite and/or the fuel;
the core has a high thermal inertia because of the mass of graphite and therefore makes it possible to limit the impact of hot or cold thermal shocks;
combined with a low value of the power per unit volume, typically equal to 2 W/cm³, the aforementioned advantages lead in practice to the elimination of the risk of serious accidents, that is to say meltdown of the core and relocation of the molten fuel.

The major disadvantages of HTR type reactors can be summarized as follows:
as already mentioned, a maximal value of the power per unit volume that is low because in part imposed by respecting the integrity of the first conferment barrier in the event of rapid depressurization of the heat transfer gas;
residual safety risks that are linked to the risks of dispersion of radioactive materials in the event of ingress of air, i.e. risks of graphite fires or water (steam explosion risks resulting from production of hydrogen);
an overall size of the steam supply system (primary vessel) that is relatively high because of a primary heat transfer gas of relatively low density that in particular imposes a large size of the components for the extraction of the heat and a loop configuration of the primary circuit that involves an arrangement of the components spread out in a number of separate premises;
a need for electrical power on site, typically several tens of MWe depending on the power of the steam production system, which is indispensable for the installation to operate, in particular for the supply of power to primary gas circulators;
a thermal power produced/electrical power consumed ratio for the circulation of the primary fluid that is less favorable for gas cooled HTR type reactors than for other reactor technologies using cooling by incompressible fluids (water, liquid metals, etc.).

Rapid neutron reactors (RNR) cooled by a liquid metal, in particular sodium (RNR-Na), and more specifically those of the fourth generation, also supply heat at temperatures compatible with the requirements of industrial production sites. The temperature of the primary sodium at the exit from the core is typically of the order of 550° C.

Rapid neutron reactors have been developed to enable improved management of the nuclear fuel, in particular by long-term management of the stock of plutonium and by the ability to monetize the inventory of uranium isotope 238, an isotope that is relatively difficult to monetize in thermal neutron reactors.

Solid fuel rapid neutron reactors rely on physical separation between the solid fuel and the liquid metal heat transfer medium by a casing (pencil or needle) forming a first physical confinement barrier (cladding). The fuel in itself consists of materials that are solid at the intended operating temperatures (notably in the form of oxides, silicon carbides (SIC) or nitrides of fissile materials or directly in the form of metal alloys). The casings are assembled into bundles and immersed with all of the other components of the primary circuit (neutron absorbing material rods, exchangers, instrumentation) directly in the liquid metal heat transfer medium, which therefore provides the thermal transfer.

The vessel of an RNR type reactor is generally designed to be suspended from a metal slab itself connected to a civil engineering vessel well.

The major advantages of RNR type reactors cooled with liquid metal, in particular RNR-Na type reactors, are that they make it possible to envisage closing the cycle of the fuel (breeder mode possibility) and the management of some high-activity long-life waste (americium, etc.) and that they have a high power density, typically of the order of 200 W/cm³.

However, known RNR-Na type reactors have the following major disadvantages:
forced convection circulation of the sodium is necessary because of the high power density;
the impossibility of a design eliminating completely the risk of a core meltdown accident (risk of loss of overall or local primary flow, risk of untimely raising of the neutron absorbing rods, etc.);
the necessity of providing a considerable quantity of equipment to prevent a core meltdown accident or to limit the associated consequences;
complex core physics with in particular a high level of coupling between thermal effects and the geometrical characteristics of the core;
because of the rapid neutron spectrum, the necessity for dedicated neutron protection (activation of structures, corrosion products, secondary fluid, etc.); because of a high residual power of the fuel, the necessity for specific infrastructures for handling fuel transfer assemblies (gas-cooled reactor hood) or storage thereof (internal storage, reactor barrels, ponds) and for handling other sodium-containing components (washing well, particular treatment of certain combustible assemblies, higher neutron protection if not sealed, etc.).

There therefore exists a need to improve solid fuel nuclear reactors cooled by liquid metal or gas for heat generation for the purposes of supplying heat for industrial production sites in order in particular to alleviate the aforementioned disadvantages.

The object of the invention is to respond at least in part to this need.

### Statement of Invention

To this end one aspect of the invention concerns a nuclear reactor cooled by liquid metal including a vessel, called the primary vessel, that is axisymmetrical about a central axis (X) and filled with a fluid containing at least one liquid metal as the heat transfer fluid of the primary circuit of the reactor, the vessel including a core including a plurality of hollow, sealed and fixed tubes arranged parallel to the axis X so that when the reactor is operating the liquid metal circulates in contact with the exterior periphery thereof, each hollow tube housing a stack of fuel assemblies housing so-called TRISO nuclear fuel particles mixed with a matrix.

In an advantageous variant embodiment the matrix in which the TRISO particles are mixed is in the form of a compact block.

In an advantageous embodiment the reactor includes a structure forming a flow restrictor with a central axis coinciding with that of the primary vessel, the structure being arranged in the primary vessel to separate the interior thereof into a central zone and a peripheral zone so that when the reactor is operating the liquid metal heat transfer fluid circulates by natural convection in a closed loop from the bottom of the central zone at which the core of the reactor is arranged in which the fission reactions occur, from which it rises by heating to the top of the central zone where it enters via an inlet at least one heat exchanger outside the. reactor vessel to exit via an outlet of the exchanger and then toward the top of the peripheral zone to descend toward the bottom of the peripheral zone where it is diverted toward the core of the reactor.

In one operating configuration as a heat-generating reactor the reactor core houses at least one moderator material.

The core of the reactor can also include a reflector made of moderator material arranged below each sealed tube.

The core of the reactor can also include at least two blocks of moderator material arranged around each sealed tube allowing the liquid metal to circulate around and in contact therewith.

In an advantageous variant embodiment each sealed tube includes a blind tubular part forming an immersion sleeve in which the fuel assemblies are stacked before the reactor begins to operate.

The liquid metal of the heat transfer fluid can be chosen from sodium (Na), lead (Pb) or a lead-bismuth (Pb—Bi) alloy.

The material of the matrix of the TRISO particles and/or of the core can be graphite.

The material constituting the sealed tubes can be a ceramic.

In another advantageous embodiment the reactor includes a reactivity control system consisting of control rods in the primary vessel.

In the context of the invention there is meant by “a moderator material” any material that enables the neutrons to be slowed down. In the usual sense the kinetic energy of a rapid neutron is greater than 1 MeV while that of a thermal neutron is less than 1 eV, typically of the order of 0.025 eV. See publication [2] and in particular its FIG. 4, which indicates for a number of reactor types the thermal fraction and the rapid fraction of the neutron flow.

Thus the invention essentially consists in a nuclear reactor with a liquid metal, in particular liquid sodium, heat transfer medium and a solid fuel assembly in the form of TRISO particles compacted in a matrix stacked with other assemblies in sealed tubes which separate the fuel from the flow of liquid metal.

The flow of liquid metal therefore circulates outside a sealed barrier. This guarantees absence of contamination in normal operation of the liquid metal, the primary heat transfer medium, by the fission products because two independent sealed barriers separate it from the fissile material contained in the TRISO particles.

The design of the reactor according to the invention in substance enables combination of the advantages of HTR type reactors and those of RNR type reactors cooled by liquid metal.

More particularly the design of the reactor according to the invention enables a significant increase in the power density of existing HTR type reactors. Indeed, the use of liquid metal at low pressure, typically 1 bar to 2 bar, replacing helium under pressure, typically at 10 bar to 100 bar, enables normal operation of the reactor with fuel temperatures higher than that of existing HTR type reactors, the TRISO particles being able to withstand these higher temperatures.

Furthermore the physical separation between the fuel with TRISO particles and the flow of liquid metal offers significant advantages.

Firstly this enables simple manipulation of the fuel (insertion in the fixed sealed tubes), because the assembly is not in contact with the liquid metal and consequently there is no need for cleaning operations. More generally, the fuel, the control rods and most of the instrumentation consisting of “consumable” components or components requiring regular replacement or inspection are positioned in a fluid zone distinct from that of the liquid metal primary heat exchange medium. This feature enables handling of components not polluted by the liquid metal heat transfer medium in order to protect most of the consumable components from any interaction with the metal.

The inventor estimates that the power density is typically around 10 MW/m³ with liquid sodium, i.e. a value five times greater than that of an HTR type reactor. Considered in parallel with the thermal robustness of the TRISO particles, this enables cooling by radiation during manipulation of the irradiated fuel, even with a high residual power, immediately after stopping the fission reaction. Given the high thermal exchange coefficient of the liquid sodium and the power density (much lower than that of rapid neutron reactors cooled by liquid metal), the thermal transfer between the fuel and the liquid metal can be achieved by simple thermal conduction.

The neutron weight of a fuel assembly is low, which enables single line replenishment, that is to say replenishment at full power, without high neutron disturbances. This online replenishment enables increased availability of the reactor and reduces the risks inherent to the replenishment operations by reducing the time pressure on this critical operation.

The characteristics of the TRISO particles also make it possible to obtain dry storage in racks cooled only by ventilation and then by radiation once placed in barrels, a few weeks after unloading the core.

Finally, the reactor according to the invention can operate with a primary liquid metal at the low pressure and high temperature of the liquid sodium, typically of the order of 750° C., at the exit from the core, which in the end makes it possible to guarantee the heat-generating vocation of the reactor for the purpose of supplying heat to industrial production sites, for example chemical installations for the production of ammonia or sodium carbonate.

Other advantages and features of the invention will become more apparent on reading the following detailed description of embodiments of the invention given by way of non-limiting illustration with reference to the following figures.

### BRIEF DESCRIPTION OF THE DRAWINGS

FIG. 1 is a schematic view in longitudinal section of a nuclear reactor according to the invention cooled by a liquid metal in a loop exchanger configuration.

FIG. 1A is a view of a detail of FIG. 1 at the level of a sealed tube housing TRISO particle assemblies between two blocks of moderator material.

FIG. 2 is another view in cross section and in perspective of a nuclear reactor according to the invention cooled by a liquid metal in a loop exchanger configuration.
FIG. 2A is a perspective view showing the insertion of a TRISO particle assembly in a sealed tube of the core from FIG. 2.

FIG. 3 is a view in cross section of a core of a nuclear reactor according to the invention showing the relative arrangements between fuel assemblies, sealed tubes and blocks of moderator material.

### DETAILED DESCRIPTION

Throughout the present application the terms “vertical”, “lower”, “upper”, “top”, “bottom”, “under” and “above” are to be understood with reference to a primary vessel filled with a liquid metal of a nuclear reactor according to the invention when in a vertical operating configuration.

The arrows symbolize the circulation of the primary liquid sodium in the reactor vessel and in the exchanger between primary and secondary circuits.

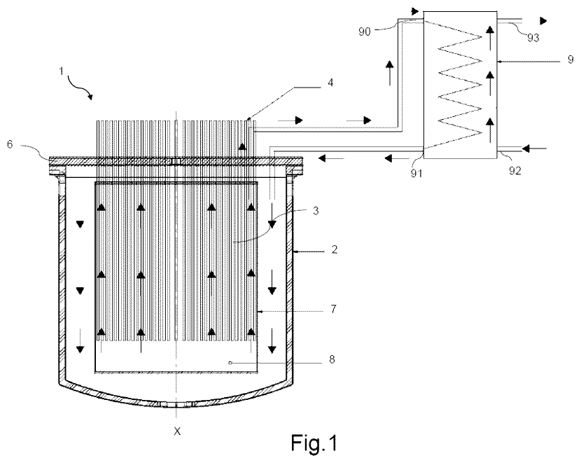

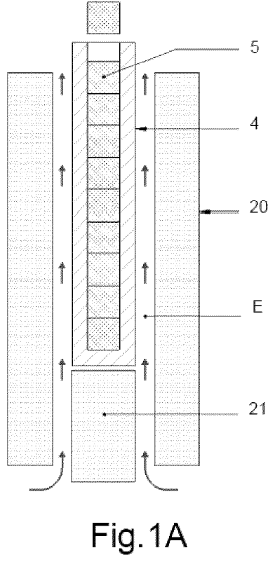

There has been represented in FIGS. 1 to 3 a nuclear reactor according to the invention cooled by a liquid metal and with fuel in the form of TRISO particles.

Such a reactor 1 includes a primary vessel 2 or reactor vessel filled with liquid sodium in the form of a right cylinder with central axis X inside which is located the core 3 in which are housed a plurality of fixed sealed tubes 4 housing removable fuel assemblies 5 containing TRISO fuel particles 50 that generate thermal energy by fission of the fuel. The liquid sodium is therefore the heat transfer fluid of the primary circuit: it stores and transports heat from the core 3.

As shown in FIG. 1A each fixed sealed tube can include a blind tubular part forming an immersion sleeve in which the fuel assemblies 5 are stacked before the reactor begins to operate. If necessary they can be replaced when the reactor is operating. The arrangement of each sealed tube 4 is such that its opening through which the fuel assemblies are stacked is at a distance from the primary liquid metal.

The solid nuclear fuels are in the form of assemblies 5 containing TRISO particles 50 compacted in a moderator material, preferably graphite, matrix 51. Each of these particles is formed of a uranium oxide core coated with layers based on carbon-containing compounds that serve as a first confinement barrier to retain the fission products.

A sheath 52 made in particular of graphite can optionally surround the matrix 51.

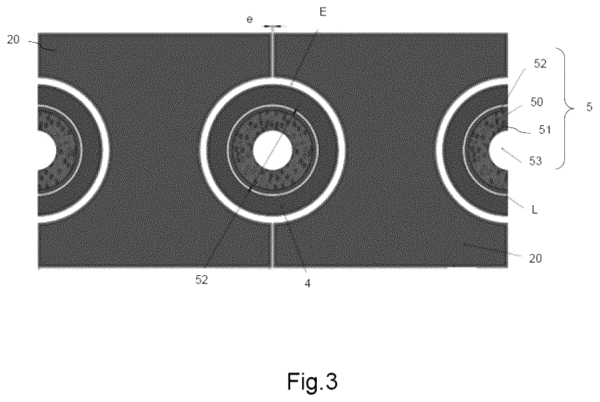

As can also be seen in FIG. 3 there can be a compact ring configuration 50, 51 and at the center of the latter a volume 53 that is empty or filled with inert gas, preferably helium, at low pressure. This volume 53 enables limitation of the core temperature of the fuel and further enables any expansion of the matrix 51 to be accommodated.

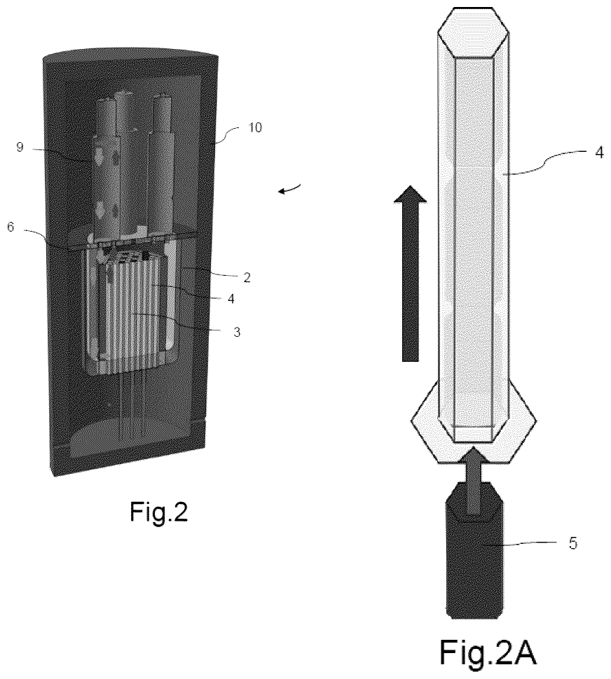

Each sealed assembly 5 can have a hexagonal exterior cross section (FIG. 2A) or a cylindrical exterior cross section (FIG. 3).

The exterior coating of the TRISO particles constitutes the main confinement barrier for the radioactive materials contained in the core 3.

A supporting slab 6 supports the primary vessel 2 and the weight of the liquid metal in the primary circuit and the weight of the internal components. This slab 6 is vertically aligned with the core 3 and closes the primary vessel 2 to contain the liquid metal to serve as a barrier between said liquid metal and the exterior surroundings.

The reactor vessel 2 is divided into two distinct zones by a separator structure consisting of at least one shroud 7 inside the reactor vessel 2. This separator device is also known as a flow restrictor (redan).

As symbolized by the arrows in FIG. 1 the flow restrictor 7 is arranged in the primary vessel 2, forming a central chimney to divide the interior of the primary vessel 10 into a central zone and a peripheral zone so that when the reactor is operating the liquid metal circulates by natural convection in a loop from the bottom of the central zone where the reactor core 3 is arranged above a bed 8 from which on heating it rises to the top of the central zone, where it enters via an inlet 90 at least one heat exchanger 9 outside the reactor vessel 2 to leave via an outlet of the exchanger 91, then toward the top of the peripheral zone and to descend toward the bottom of the peripheral zone from where it is diverted to the core 3.

Thus in normal operation the primary liquid metal circulates only by natural convection in the reactor vessel 2 and in a closed loop through at least one exchanger 9 and exchanges its heat in the latter with a secondary fluid that enters cold via the inlet 92 and leaves hot via the outlet 93. The temperature of the secondary fluid at the outlet 93 can typically be equal to 700° C.

The shape of the flow restrictor 7 enables improved circulation by natural convection of the liquid metal.

The reactor 1 includes a reactivity control system that is not represented that can consist of control rods internal to the primary vessel 2.

The reactor vessel 2 includes an upper part, usually called the core head, which can be filled with an inert gas, such as argon or helium, above the liquid metal. This upper part makes it possible to absorb the thermal expansion of the liquid metal in the reactor vessel when it undergoes a variation of level and to recover the gas fission products generated by nuclear fission in the fuels.

An advantageous arrangement of a sealed tube 4 housing a stack of fuel assemblies 5 is shown in FIG. 1A. The sealed tube 4, which is preferably made of ceramic, is arranged between at least two blocks 20 of moderator material, preferably graphite. This arrangement allows the primary liquid metal to circulate around and in contact with the sealed tube in a clearly defined space E.

A reflector 21 made of moderator material, preferably graphite, can be arranged below a sealed tube 4.

An advantageous arrangement is shown in FIG. 3 for sealed tubes 4 and fuel assemblies 5 of right cylindrical cross section. A tube 4 is arranged between two blocks 20 of moderator material, preferably graphite, arranged side-by-side leaving a gap e between them and a larger space E in which the liquid metal circulates when the reactor is operating.

In this FIG. 3 a volume for filling with an inert gas, preferably helium, can be provided between a fuel assembly 5 and the interior of the sealed tube 5 in order to improve the thermal interface for thermal conduction of the heat generated by the fission of the TRISO particles.

The invention is not limited to the examples that have just been described; there can in particular be combined with each of them other features of the examples depicted in variants that are not depicted.

Other variants and embodiments can be envisaged without departing from the context of the invention.

Liquid metals other than sodium can be envisaged for the primary fluid: it can be lead (Pb) or a lead-bismuth (Pb—Bi) alloy.

Materials other than graphite can also be envisaged for the matrix of the TRISO particles and/or the core, for example aluminum.

As shown in FIG. 2 the reactor 1 can include a concrete sealed enclosure 10 to house the primary vessel 2.

### LIST OF REFERENCES CITED

[1]: “High-temperature gas-cooled reactors and industrial heat applications”, NEA No. 7629, OECD, Paris, 2022.
[2]: Jiri Krepel et al. “Self-Sustaining Breeding in Advanced Reactors: Characterization of Selected Reactors”, Encyclopedia of Nuclear Energy 2021, Pages 801-819. https://www.sciencedirect.com/science/article/pii/B9780128197257001239?via%3Dihub

1. A nuclear reactor cooled by liquid metal including a vessel, called the primary vessel, that is axisymmetrical about a central axis (X), filled with a heat transfer fluid containing at least one liquid metal as the heat transfer fluid of the primary circuit of the reactor, the vessel including a core including a plurality of hollow, sealed and fixed tubes arranged parallel to the axis X so that when the reactor is operating the liquid metal circulates in contact with the exterior periphery thereof, each hollow tube housing a stack of fuel assemblies housing so-called TRISO nuclear fuel particles mixed with a matrix, wherein each seated and fixed tube includes a blind tubular part forming an immersion sleeve in which the fuel assemblies are stacked before the reactor begins to operate.

2. The nuclear reactor as claimed in claim 1, wherein the matrix in which the TRISO particles are mixed, is in the form of a compact block.

3. The nuclear reactor as claimed in claim 1, including a structure forming a flow restrictor with a central axis coinciding with that of the primary vessel, the structure being arranged in the primary vessel to separate the interior thereof into a central zone and a peripheral zone so that when the reactor is operating the liquid metal heat transfer fluid circulates by natural convection in a closed loop from the bottom of the central zone at which the core of the reactor is arranged in which the fission reactions occur, from which it rises by heating to the top of the central zone where it enters via an inlet at least one heat exchanger outside the reactor vessel to exit via an outlet of the exchanger and then toward the top of the peripheral zone and to descend toward the bottom of the peripheral zone where it is diverted toward the core of the reactor.

4. The nuclear reactor as claimed in claim 1, wherein the reactor core houses at least one moderator material.

5. The nuclear reactor as claimed in claim 4, wherein the core of the reactor includes a reflector made of moderator material arranged below each sealed tube.

6. The nuclear reactor as claimed in claim 4, wherein the core of the reactor includes at least two blocks of moderator material arranged around each sealed tube allowing the liquid metal to circulate around and in contact therewith.

7. (canceled)

8. The nuclear reactor as claimed in claim 1, wherein the liquid metal of the heat transfer fluid is chosen from sodium (Na), lead (Pb) or a lead-bismuth (Pb—Bi) alloy.

9. The nuclear reactor as claimed in claim 1, wherein the material of the matrix of the TRISO particles and/or of the core is graphite.

10. The nuclear reactor as claimed in claim 1, wherein the material constitutes the sealed tubes being a ceramic.

11. The nuclear reactor as claimed in claim 1 including a reactivity control system consisting of control rods in the primary vessel.
